(19) United States
(12) Patent Application Publication
(10) Pub. No.: US 2006/0065060 A1
(43) Pub. Date: Mar. 30, 2006

(54) Pressure detecting mat and antidecubitus system provided with the same

(75) Inventors: Eiichi Ito, Chiba-ken (JP); Mitsuhiro Matsumoto, Tokyo (JP); Koji Tsuda, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/235,177

(22) Filed: Sep. 27, 2005

(30) Foreign Application Priority Data
Sep. 28, 2004 (JP) 2004-281351

(51) Int. Cl. G01D 7/00

(52) U.S. Cl. 73/862.046

(57) ABSTRACT

A pressure-detecting mat includes a plurality of communication modules that are configured to communicate with each other using the two dimension diffusive signal-transmission technology, a module layer that includes the plurality of communication modules scattered therein, a plurality of conductive layers that electrically interconnect the plurality of communication modules, at least two insulating layers that sandwich the module layer and the plurality of conductive layers, and a plurality of pressure sensors that are arranged in one of all the layers except the farthest layer in a pressure applying direction. Each of the pressure sensors being capable of detecting a pressure and communicating with each of the communication modules to send an output signal according to the detected pressure to each of the communication modules. The total stiffness of the layers that are farther in the pressure applying direction than the layer in which the pressure sensors are arranged is higher than the total stiffness of the layers that are closer in the pressure applying direction than the layer in which the pressure sensors are arranged.

### BACKGROUND OF THE INVENTION

The present invention relates to a pressure-detecting mat using a two dimension diffusive signal-transmission technology and an antidecubitus system provided with the pressure-detecting mat.

Conventionally, a fluid pressure using mat device has been known, which provides comfortable feelings to a patient who sleeps, sits, and reclines thereon by keeping a suitable inner pressure of a chamber in which fluid is sealed, the chamber being located in a certain layer of the mat.

An example of such a fluid pressure using mat device is disclosed in Japanese Patent Provisional Publication No. HEI 11-76317. In a fluid pressure using mat device as indicated in this publication, it is not allowed to arrange a number of chambers and a number of pressure-detecting sensors in each of the chambers to avoid complicated wiring of various kinds of electrical elements such as a pressure-detecting sensor. As a result, since the area of a patient body surface covered by one chamber is large, it is impossible to make fine pressure detection.

### SUMMARY OF THE INVENTION

The present invention is advantageous in that a pressure-detecting mat, which finely detects a pressure applied to the mat, and an antidecubitus system using the pressure-detecting mat are provided.

According to an aspect of the invention, there is provided a pressure-detecting mat that is capable of detecting a pressure using a two dimension diffusive signal-transmission technology including a plurality of communication modules that are configured to communicate with each other using the two dimension diffusive signal-transmission technology, a module layer that includes the plurality of communication modules scattered therein, a plurality of conductive layers that electrically interconnect the plurality of communication modules, at least two insulating layers that sandwich the module layer and the plurality of conductive layers, and a plurality of pressure sensors that are arranged in one of all the layers except the farthest layer in a pressure applying direction, each of the pressure sensors being capable of detecting a pressure and communicating with each of the communication modules to send an output signal according to the detected pressure to each of the communication modules. The total stiffness of the layers that are farther in the pressure applying direction than the layer in which the pressure sensors are arranged is higher than the total stiffness of the layers that are closer in the pressure applying direction than the layer in which the pressure sensors are arranged.

Optionally, among at least two insulating layers, one of the layers that are farter in the pressure applying direction than the layer in which the pressure sensors are arranged may have higher stiffness than any other layers.

Optionally, each of the communication modules may be configured to judge whether the output signal from a corresponding one of the pressure sensors satisfies at least one predetermined condition. Optionally, each of the communication modules may be configured to transmit a warning signal for warning about that the output signal is abnormal to an external system, when one of the communication modules judges that the output signal satisfies the at least one predetermined condition.

Further optionally, each of the communication modules may be configured to transmit its own ID information to the external system, when one of the communication modules judges that the output signal satisfies at least one predetermined condition.

Yet optionally, the at least one predetermined condition may include a first condition that the output signal is equal to or higher than a first threshold.

Optionally, each of the pressure sensors may be configured to detect a pressure and to send the output signal according to the detected pressure to each of the communication modules every first timing. Optionally, each of the communication modules may be configured to calculate every second timing a summation of all of the output signals received every first timing thereby during a period between the previous second timing and the second timing, the period between each adjacent couple of the second timings being longer than the period between each adjacent couple of the first timings. Optionally, the at least one predetermined condition may include a second condition that the calculated summation is equal to or higher than a second threshold, the second threshold being higher than the first threshold.

Still optionally, each of the communication modules may be configured to calculate a difference between the output signals from each adjacent couple of the pressure sensors. Optionally, the at least one predetermined conditions may include a third condition that the calculated difference is equal to and higher than a third threshold, the third threshold being lower than the first threshold.

According to another aspect of the invention, there is provided an antidecubitus system including one of the aforementioned pressure-detecting mats and the external system that is configured to receive the warning signal. The external system is provided with a controlling system that is configured to communicate with each of the plurality of communication modules, and a warning system that is configured to warn about an abnormal pressure being applied to the pressure-detecting mat, the warning system being connected with the controlling system. The controlling system instructs the warning system to warn about an abnormal pressure being applied to the pressure-detecting mat in accordance with the received warning signal.

Alternatively or optionally, the controlling system may be configured to communicate with each of the plurality of communication modules to receive the output signal. Optionally, the controlling system may judge whether the output signal satisfies at least one predetermined condition. Optionally, the controlling system may instruct the warning system to warn about an abnormal pressure being applied to the pressure-detecting mat, when the controlling system judges that the output signal satisfies the at least one predetermined condition.

Alternatively or optionally, the controlling system is configured to receive the ID information from each of the communication modules.

Alternatively or optionally, the controlling system may receive the output signal from each of the communication modules every first timing to calculate every second timing a summation of all of the output signals during a period between the previous second timing and the second timing, the period between each adjacent couple of the second timings being longer than the period between each adjacent couple of the first timings.

Alternatively or optionally, the controlling system may be configured to calculate a difference between the output signals from each adjacent couple of the pressure sensors.

### BRIEF DESCRIPTION OF THE ACCOMPANYING DRAWINGS

FIG. 1 schematically shows the constitution of an antidecubitus system in a first embodiment according to the present invention;

FIG. 2 shows the cross-sectional structure of the pressure-detecting mat in the first embodiment according to the present invention;

FIG. 3 is a block diagram showing the configuration of a communication module in the first embodiment according to the present invention;

FIG. 4 is a flowchart showing a body pressure judging process of the communication module in the first embodiment according to the present invention;

FIG. 5 is a flowchart showing a body pressure judging process of a communication module in a second embodiment according to the present invention;

FIG. 6 is a figure illustrating the relationship between each of local addresses and each of the communication modules;

FIG. 7 is a block diagram showing the configuration of a control unit in the first and second embodiments according to the present invention;

FIG. 8 is a flowchart showing a warning signal converting processing carried out by the control unit in the first and second embodiments according to the present invention;

FIGS. 9-14 show various examples of warning indications displayed on a monitor;

FIG. 15 is a flowchart showing a body pressure judging process carried out by a control unit in a third embodiment according to the present invention;

FIG. 16 conceptually shows an address structure of a memory to make it easy to explain the process in the flowchart shown in FIG. 15;

FIG. 17 is a flowchart showing a body pressure judging process according to an integral evaluation in S70 shown in FIG. 15;

FIG. 18 is a flowchart showing a body pressure judging process according to a differential evaluation in S80 shown in FIG. 15;

FIG. 19 shows the cross-sectional structure of a pressure-detecting mat in a fourth embodiment according to the present invention;

FIG. 20 shows the cross-sectional structure of a pressure-detecting mat in a fifth embodiment according to the present invention;

FIGS. 21-24 show the cross-sectional structures of various types of pressure-detecting mats, each of which is provided with a layer including a plurality of chambers thereon;

FIG. 25 is a block diagram showing the configurations of a communication module and a pressure sensor module provided in the pressure-detecting mat shown in FIG. 24;

FIG. 26A shows the cross section of a pressure-detecting mat provided with insulating layers that have the same stiffness;

FIG. 26B shows the cross section of a pressure-detecting mat provided with insulating layers, farther one of the insulating layers in the pressure applying direction being of higher stiffness than the other;

FIG. 27 shows the cross-sectional structure of a pressure-detecting mat in a sixth embodiment according to the present invention; and

FIG. 28 shows the cross-sectional structure of a pressure-detecting mat in a seventh embodiment according to the present invention.

### DETAILED DESCRIPTION OF THE EMBODIMENTS

Each of antidecubitus systems in embodiments according to the present invention is provided with a pressure-detecting mat that is unique in the present invention. This pressure-detecting mat directly detects a pressure equivalent to a body pressure of a patient. In addition, the pressure-detecting mat includes a circuit for obtaining the pressure applied to each point on the mat, the circuit making it unnecessary to use a wired cable and/or a copper film pattern inside the pressure-detecting mat. Thereby, it is allowed to incorporate higher density of pressure sensors, to arrange the pressure sensors more flexibly, to obtain a fine pressure map, and to capture a signal of the pressure value with a high S/N ratio. Hereinafter, the constitution and the operation of each of the antidecubitus systems of the embodiments will be explained with reference to the accompanying drawings.

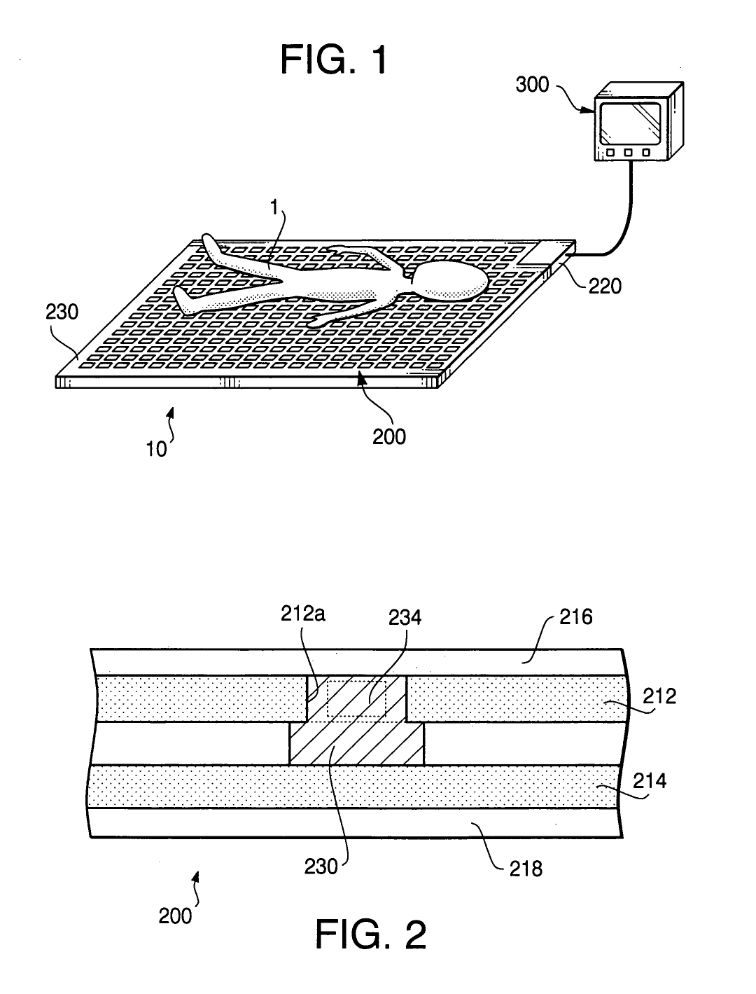

FIG. 1 schematically shows the constitution of an antidecubitus system 10 of a first embodiment according to the present invention. In the first embodiment, a pressure value equivalent to a body pressure of a patient 1 is obtained by the antidecubitus system 10, and warning processing for preventing the patient 1 from suffering decubitus is carried out based on the obtained result.

The antidecubitus system 10 is configured with a pressure-detecting mat 200 on which the patient 1 lies, a control unit 220 that is provided in the mat and comprehensively controls the system 10, a plurality of communication modules 230 for obtaining the above pressure value, and a monitor 300 capable of warning people about that the pressure value obtained by the pressure-detecting mat 200 is abnormal. The control unit 220 is located at one of four corners of the pressure-detecting mat 200, and the plurality of communication modules 230 are arranged like a matrix on a predetermined plane in the pressure-detecting mat 200 as shown in FIG. 1. It is noted that the location of the control unit 220 is not limited at one of the four corners of the pressure-detecting mat 200, and may be, for example, near the center of any one side of the pressure-detecting mat 200.

FIG. 2 shows the cross-sectional structure of the pressure-detecting mat 200. The pressure-detecting mat 200 utilizes a substrate using a two dimension diffusive signal-transmission technology (which is briefly explained in http://www.utri.co.jp/biz/index02_{—}02.html at the time of Sep. 15, 2005, and hereinafter, is simply referred to as a 2D-DST), or utilizes a part of the constitution of a communication device disclosed in Japanese Patent Provisional Publication No. P2003-188882 (that is, a device which sends packets of desired data to a destination by connecting each adjacent couple of a plurality of chips in an insulating layer with one another using two conductive layers, the insulating layer being sandwiched by the two conductive layers and formed with the plurality of chips scattered therein), and is provided with four laminated layers in total, i.e., two conductive layers 212 and 214, and two insulating layers 216 and 218 for electrically isolating the conductive layers 212 and 214 from outside, and further, an insulating layer formed with a plurality of communication modules 230 scattered between the conductive layers 212 and 214 as shown in FIG. 1. It is noted that although the plurality of communication modules 230 are scattered in the insulating layer in the first embodiment, they may be scattered in another layer such as a high resistance layer and a derivative layer in another embodiment.

The two conductive layers 212 and 214 have flexibility and conductivity, and spread substantially all over the pressure-detecting mat 200, with wideness enough for the patient 1 to lie, as shown in FIG. 1. These layers, for instance, are made of conductive rubber, cloth textured with conductive material, or a mesh metal plate. The conductive layers 212 and 214, between which there are provided the communication modules 230 and insulating layers not shown in FIG. 1, are located with a predetermined space therebetween. Thereby, the conductive layers 212 and 214 are laminated such that they are electrically isolated from one another. Moreover, the conductive layer 212 is arranged closer to the patient 1 than the conductive layer 214. In other words, the conductive layer 212 is located on the upper side surface of the pressure-detecting mat 200 (that is, the side surface on which the patient 1 lies), and the conductive layer 214 is located on the lower side surface thereof (that is, the side surface which has contact with a bed or a floor).

The insulating layer 216 is a flexible layer of insulation, and spreads substantially all over the pressure-detecting mat 200, with wideness enough for the patient 1 to lie, as shown in FIG. 1. In addition, the insulating layer 216 is laminated on the upper side surface of the conductive layer 212 (that is, the side surface closer to the patient 1), and, for instance, is made of insulating rubber or a relatively thick cloth of insulation. Since the insulating layer 216 has direct contact with the patient 1, it may be formed from a more flexible material if the comfort for the patient 1 sleeping thereon is given higher priority.

The insulating layer 218, which has higher stiffness and insulation characteristics than the insulating layer 216, is laminated on the lower side surface of the conductive layer 214 (that is, the side surface farther from the patient 1), and spreads substantially all over the pressure-detecting mat 200, with wideness enough for the patient 1 to lie, as shown in FIG. 1.

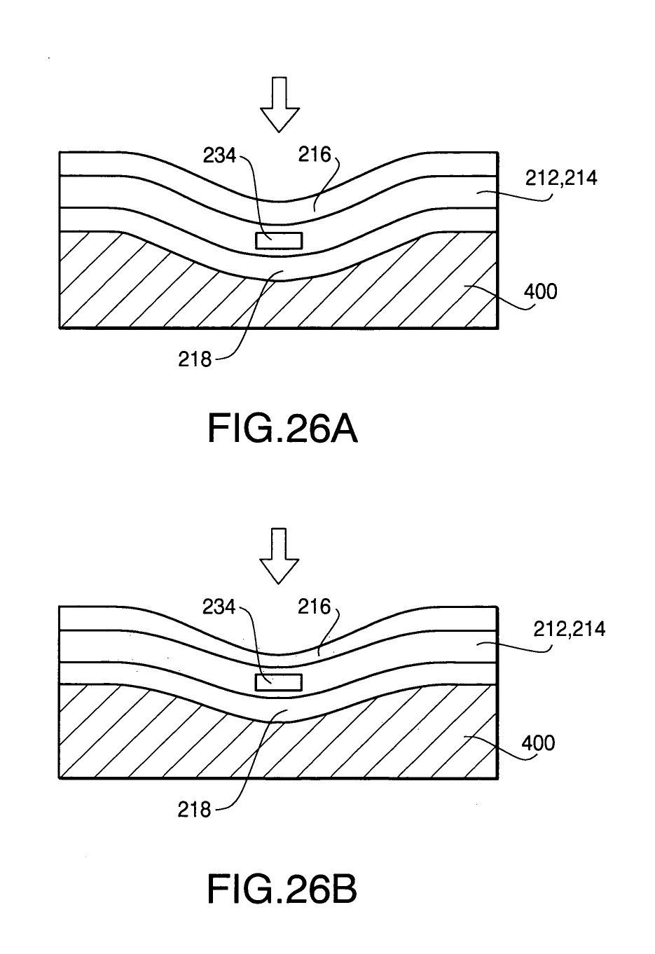

Next, the pressure detection sensitivity depending on the stiffness of each layer will be explained with reference to FIGS. 26A and 26B. It is noted that for simplicity, the conductive layers 212 and 214, and the insulating layer with the communication modules 230 and pressure sensors 234 scattered therein are represented as one layer.

FIG. 26A shows the cross section of the pressure-detecting mat provided with the insulating layers 216 and 218 that have the same stiffness. For example, when such a pressure-detecting mat is put on an object that is easy to be elastically deformed, such as a bed 400, the insulating layers 216 and 218, which have the same stiffness, are deformed in a similar fashion. Therefore, the pressure that should be applied between the insulating layers (that is, to the pressure sensor 234) is applied mainly to the bed 400. The pressure sensor 234 incorporated in such a pressure-detecting mat cannot detect the body pressure with high sensitivity.

FIG. 26B shows the cross section of the pressure-detecting mat provided with the insulating layers 216 and 218, the insulating layer 218 being of higher stiffness than the insulating layer 216. For example, when such a pressure-detecting mat is put on an object that is easy to be elastically deformed, such as a bed 400, the difference in stiffness between the insulating layers 216 and 218 causes pressure difference between the upper and lower sides of the pressure sensor 234 in accordance with the pressure applied to the pressure-detecting mat. Therefore, the pressure sensor 234 can detect the body pressure with higher sensitivity than that in the case shown in FIG. 26A. It is noted that when the stiffness of the layer farther from the patient 1 than the conductive layer 212 in which the pressure sensor 234 is incorporated is set higher than that of the layer closer to the patient 1 than the conductive layer 212, the detection sensitivity is improved such that the pressure is detected as a higher one by the pressure sensor 234. For this reason, the insulating layer 218 that is a bottom layer is formed from material of higher stiffness than the insulating layer 216 that is a top layer. All pressure-detecting mats in embodiments according to the present invention, except for a pressure-detecting mat 200H shown in FIG. 28, have such a structure of layers with different stiffnesses. In addition, for a similar reason to the case of the aforementioned insulating layers, the stiffness of the conductive layer 214 farther from the patient 1 than the conductive layer 212 may preferably be set higher than that of the conductive layer 212.

Due to the function of the insulating layers 216 and 218, even though a current flows through the conductive layer 212 or the conductive layer 214, the insulation characteristics between the conductive layer 212 or the conductive layer 214 and the outside (for instance, the body surface of the patient 1) can be maintained.

Next, the constitution and operation of the communication module 230 will be explained. The major functions of the communication module 230 are to obtain the value of the body pressure of the patient 1, to perform judgment processing for the obtained body pressure value, and to generate and transmit a warning signal for warning an abnormal body pressure (in this case, to transmit the warning signal to the control unit 220) on the basis of the judgment processing.

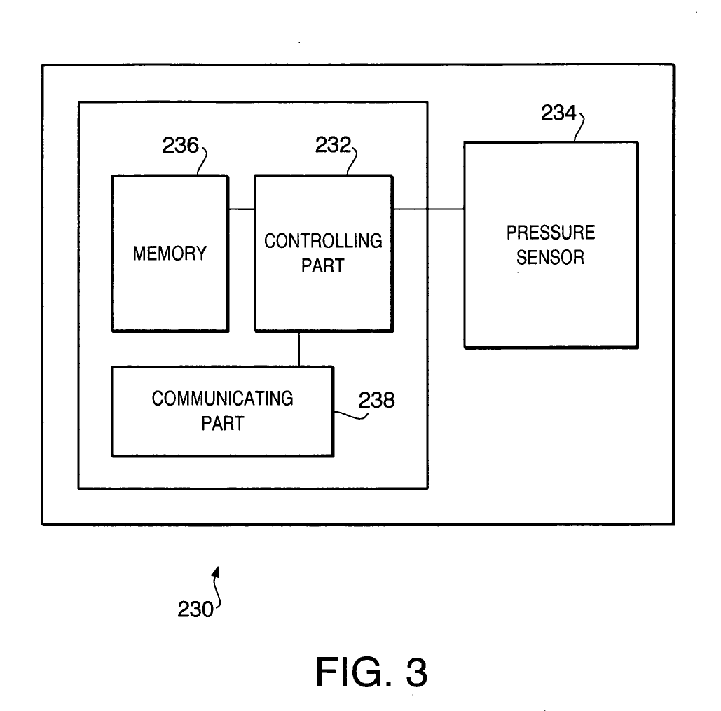

FIG. 3 is a block diagram showing the configuration of the communication module 230. The communication module 230 is configured with a controlling part 232 that controls the whole of the module, the pressure sensor 234 that measures the body pressure of the patient 1 (for example, a widely known diaphragm-type or semiconductor-type pressure sensor), a memory 236 that stores various kinds of data such as ID information of the module and the pressure value, and communicating part 238 that transmits a signal by means of the 2D-DST.

The conductive layer 212, as shown in FIG. 2, is formed with an opening 212a that improves a contact condition between the communication module 230 (more specifically, the pressure sensor 234) and the patient 1. The pressure sensor 234 is located as being buried in the opening 212a. Thereby, such an effect of the opening 212a improves the contact condition between the pressure sensor 234 and the patient 1 to make the sensitivity of the pressure sensor 234 better.

It is noted that all the pressure sensors 234, which the pressure-detecting mat 200 in the first embodiment includes, are arranged like a matrix in a predetermined plane that is a plane in the conductive layer 212 and is parallel to each of the layers. For this reason, the same is the distance in a laminating direction between the upper surface of the insulating layer 216 that has a contact with the patient 1 and each of the pressure sensors 234. Therefore, when a uniform pressure is applied to whole region of the upper surface of the insulating layer 216, each of the pressure sensors 234 detects the same pressure value

In addition, as aforementioned, when the pressure-detecting mat 200 is configured such that the bottom of the pressure-detecting mat 200, that is, the insulating layer 218 has higher stiffness to restrain deformation thereof, displacement between each of the pressure sensors 234 and the bottom is hard to occur due to flexure of the pressure-detecting mat 200. In other words, the upper insulating layer 216 is deformed by applying a pressure thereto to transmit the pressure to each of the pressure sensors 234, while the lower insulating layer 218 has the higher stiffness to keep the position of each of the pressure sensors 234. Thereby, it is possible to detect the pressure with high S/N ratio.

Moreover, the communication module 230 in the first embodiment, as shown in FIG. 2, is exposed only at the opening 212a, and any other portions except for the opening 212a are covered with the conductive layers 212 and 214. Therefore, the conductive layers 212 and 214 block or attenuate radio waves going from external devices arranged around the pressure-detecting mat 200 to the communication module 230 at every region of the conductive layers 212 and 214 except for the opening 212a not to have the communication module 230 receive unnecessary noises. From another viewpoint, the conductive layers 212 and 214 block and attenuate noises emitted from the communication module 230 to the surround. Consequently, the pressure sensor 234 can obtain a detecting signal of the body pressure value with high S/N ratio.

It is noted that a communication module that is not provided with the pressure sensor 234 (i.e., a communication module that is provided only with the controlling part 232, the memory 236, and the communicating part 238) may be applied. Such a communication module functions as a transmission site when a signal is transmitted to a destination (in this case, the control unit 220) with a packet using the above 2D-DST. It is needless to say that the communication module 230 provided with the pressure sensor 234 can function as a transmission site in the case of signal transmission using the 2D-DST.

The communication module that functions as a transmission site without the pressure sensor 234 can be fabricated with lower cost than the communication module 230 with the pressure sensor 234. In addition, when such a communication module is arranged in the pressure-detecting mat 200, unlike with the communication module 230 provided with the pressure sensor 234, it is unnecessary for the conductive layer 212 to be formed with the opening 212a. Therefore, even if a number of such communication modules are arranged in the pressure-detecting mat 200, it will not cost so much compared with the case of the communication module 230 with the opening 212a.

By arranging a number of communication modules as transmission sites in the pressure-detecting mat 200 as aforementioned, reliability of a circuit using the above 2D-DST (in other words, certainty of signal transmission) is improved. For instance, the number of the communication modules is proportional to the number of alternatives of communication channels of various kinds of signals. Therefore, even if the above alternatives are reduced by failures of some communication modules, the absolute number of the alternatives is maintained by arranging a number of communication modules to transmit a warning signal to the control unit 220 more certainly. Moreover, since the increase of the alternatives leads to increasing the communication channels that might be shorter, faster transmission of the warning signal to the control unit 220 is feasible.

In the first embodiment, the pressure sensors 234 (or the communication modules 230) are arranged like a matrix on a predetermined plane, while, in another embodiment, the pressure sensors 234 may be arranged locally at the center region of the pressure-detecting mat 200 which is more likely to have a contact with the patient 1. By arranging the pressure sensor 234 in such a manner, the number of the pressure sensors 234 that actually detects the body pressure tends to be increased to allow fine detection of the body pressure.

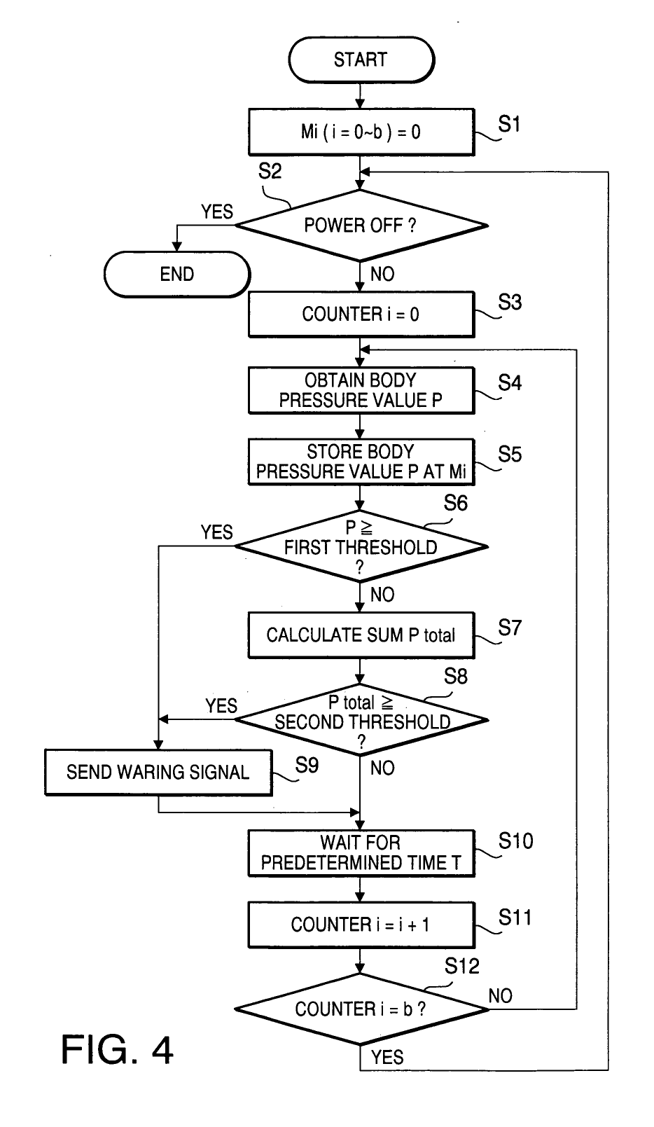

FIG. 4 is a flowchart that shows a body pressure judging process for judging whether the body pressure detected by the pressure sensor 234 is abnormal or not, the process being carried out by the controlling part 232 of the communication module 230 in the first embodiment. Hereinafter, the body pressure judging process will be explained with reference to FIG. 4. It is noted that although the below-mentioned explanation relates to the process performed by one of the communication modules 230, this body pressure judging process is carried out by all of the communication modules 230.

When a power supply of the control unit 220 is turned on, a driving voltage is supplied to the communication module 230 such that the controlling part 232 sets values stored at addresses Mi (i=0, 1, 2, . . . , a, b) of the memory 236 equal to zero (step 1, hereinafter, “step” will be shown as “S” for brevity). Then, the controlling part 232 checks whether the driving voltage is supplied to the communication module 230, that is, whether the power supply of the control unit 220 is off (S2). In this step, when the power supply of the control unit 220 is off (S2: YES), this process is terminated. On the other hand, when the power supply of the control unit 220 is on (S2: NO), this process proceeds to S3.

After setting a counter i that is associated with the addresses Mi in S3 equal to zero, the controlling part 232 obtains a body pressure value P detected by the pressure sensor 234 (S4). Then, the body pressure value P is stored into one of the addresses Mi of the memory 236 (S5). For example, the first-obtained body pressure value P is stored into the address M0 as the counter i equals to zero.

The controlling part 232, next, judges whether the body pressure value P is higher than a first threshold (S6). In this step, when the body pressure value P is judged equal to or higher than the first threshold (S6: YES), an extremely high pressure is applied to at least one portion of the pressure-detecting mat 200, and it is possible that the patient 1 suffers from decubitus. Accordingly, the controlling part 232 generates a warning signal for warning the possibility of decubitus, which is outputted to the control unit 220, together with the ID information stored in the memory 236 (S9). The warning signal outputted in this step is continuously transmitted from one of the respective communicating parts 238 provided in a plurality of communication modules 230 to another one by means of the 2D-DST to reach the control unit 220. On the other hand, when the body pressure value P is judged lower than the first threshold (S6: NO), such a high pressure is not applied to the pressure-detecting mat 200, and the patient 1 is less likely to suffer from decubitus. Therefore, the controlling part 232 makes this process proceed to S7 without generating the warning signal.

The controlling part 232 calculates a summation Ptotal of the body pressure values stored at the addresses M0˜Mb in S7, and judges whether the summation Ptotal is higher than a second threshold (S8). In this step, when the summation Ptotal is judged equal to or higher than the second threshold (S8: YES), as described below, a relatively high pressure is continually applied to at least one portion of the pressure-detecting mat 200, and it is possible that the patient 1 suffers from decubitus. In this case, the controlling part 232 generates a warning signal, which is outputted to the control unit 220 together with the ID information (S9). On the other hand, when the summation Ptotal is judged lower than the second threshold (S8: NO), it does not mean that a relatively high pressure is continually applied to the pressure-detecting mat 200, and that the patient 1 is likely to suffer from decubitus. Accordingly, the controlling part 232 makes the process proceed to S10 without generating the warning signal. It is noted that the second threshold used in this step is higher than the first threshold.

After waiting ready for a predetermined time T in S10, the controlling part 232 increments the counter i by one (S11). Then, the controlling part 232 checks whether the current value of the counter i is b (S12). In this step, when the counter i is b (S12: YES), all of the addresses in the memory 236, at which the body pressure values P are stored, are occupied, and therefore, the controlling part 232, going back to S2, carries out this process again. In addition, when the counter i is not b (S12: NO), since there is at least one vacant address in the memory 236, the controlling part 232, going back to S4, obtains the body pressure value P, and repeats the aforementioned steps.

It is noted that the steps of S4 to S12 are repeatedly carried out every first timing (substantially every predetermined time T). Therefore, the controlling part 232 obtains the body pressure value P every first timing. When an extremely high pressure is applied to the patient 1 even for a short while, the patient 1 suffers from various kinds of strains (including decubitus). The controlling part 232 prevents for the patients to suffer from the above-mentioned strains by the judging process utilizing the body pressure value P.

Moreover, the summation Ptotal is obtained every second timing. The period between each adjacent couple of the second timings is longer than that between each adjacent couple of the first timings, and is represented as the product of the predetermined time T and any of 2 to (b+1). When a relatively high pressure is continually applied to the patient 1 even if the applied pressure is lower than the first threshold, it is possible that the patient 1 suffers from decubitus. The controlling part 232 warns about the possibility of the patient 1 suffering decubitus.

Next, a body pressure judging process that a controlling part 232 of a communication module 230 carries out in a second embodiment will be described.

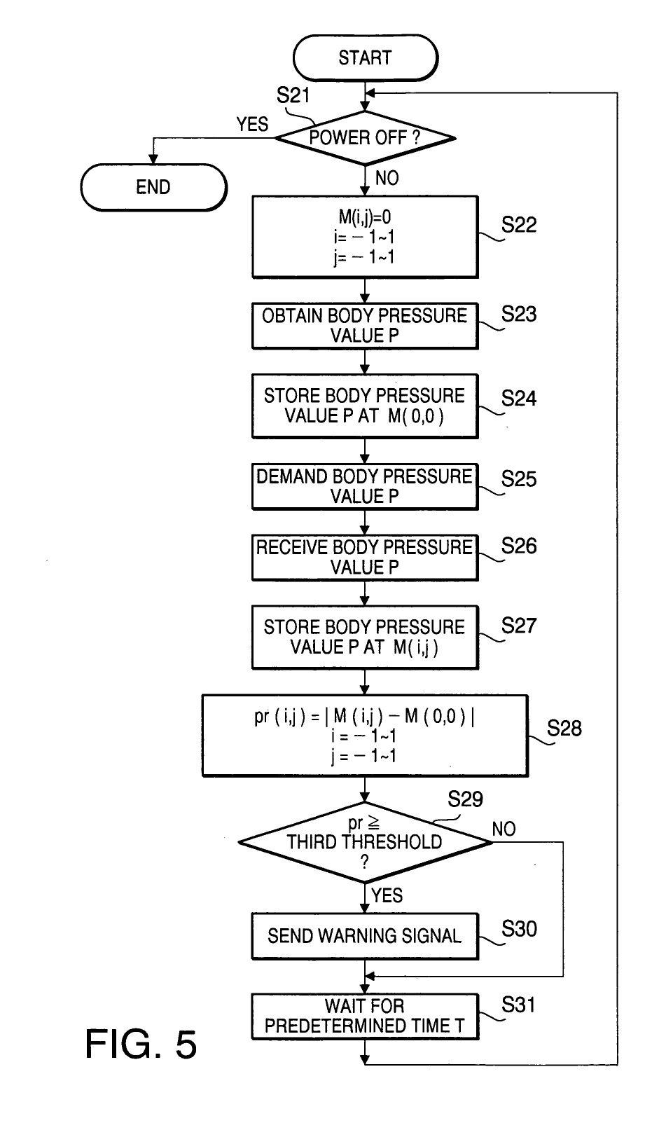

FIG. 5 is a flowchart showing a body pressure judging process in a second embodiment. Hereinafter, the body pressure judging process of the second embodiment will be explained with reference to FIG. 5. It is noted that the below-mentioned explanation relates to a process that is carried out by the single communication module 230, in the same way as the above-mentioned body pressure judging process, but, needless to say, this body pressure judging process is performed by every communication module 230.

When the power supply of the control unit 220 is turned on, a driving voltage is supplied to the communication module 230, and the controlling part 232 first checks whether the driving voltage is supplied or not (that is, whether the power supply of the control unit 220 is off or not) (S21). In this step, when the power supply of the control unit 220 is off (S21: YES), this process is terminated. On the other hand, the power supply of the control unit 220 is on (S21: NO), this process proceeds to S22.

In this step, the communication module 230, in addition to having its own ID information to be sent to the control unit 220, assigns local addresses to itself and each of adjacent communication modules 230 thereto for the sake of convenience. The communication module 230 also stores the body pressure value P detected by each of the communication modules 230 at a corresponding address of the memory 236 whose code is the same as that of each of the local addresses.

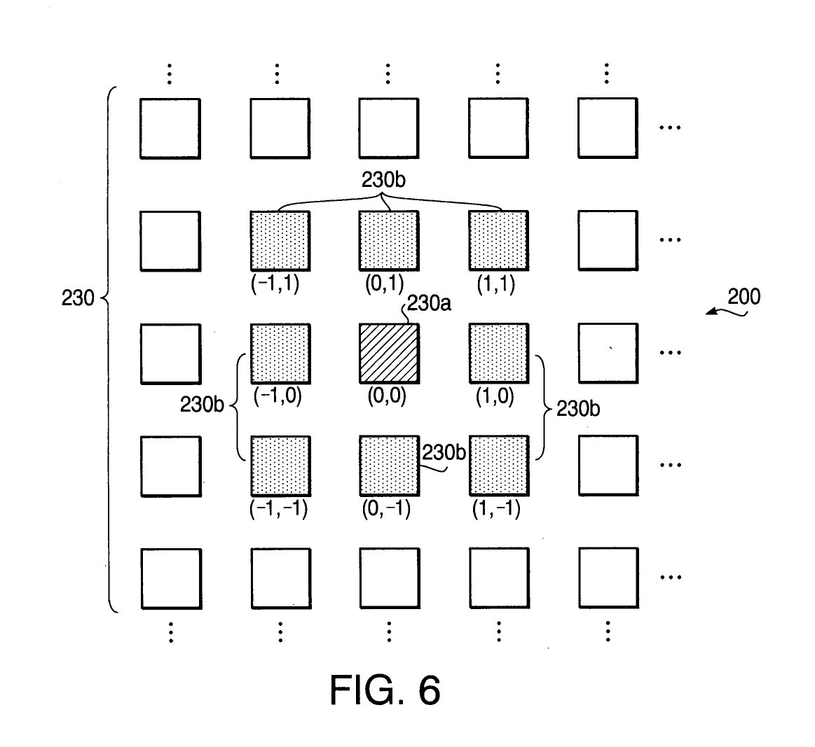

FIG. 6 is a figure illustrating the relationship between each of the local addresses and each of the communication modules. It is noted that the communication module 230, which is shaded by a slash pattern and located at the center of FIG. 6, carries out the process of the flowchart in this explanation, and, for convenience, is referred to as a communication module 230a. In addition, eight communication modules 230 shaded by dot patterns are adjacent communication modules to the communication module 230a, and, for convenience, are referred to as adjacent communication modules 230b. The communication module 230a assigns its own local address as (0, 0), and the local addresses of the eight adjacent communication modules 230b as (−1, 1), (0, 1), (1,1), (−1, 0), (1, 0), (−1, −1), (0, −1), and (1, −1), as shown in FIG. 6.

In S22, the controlling part 232 sets a value equal to zero, the value being stored in each of the addresses M (i, j) (where i=−1˜1, and j=−1˜1), and obtains the body pressure value P of the patient 1 detected by the pressure sensor 234 (S23). Then, the controlling part 232 stores the body pressure value P at the address M (0, 0) of the memory 236 that is associated with its own local address (S24). Furthermore, the controlling part 232 sends a signal demanding the body pressure value P detected by each of the eight adjacent communication modules 230b, to which the local addresses are designated, to each of the adjacent communication modules 230b (S25). Each of the adjacent communication modules 230b transmits the body pressure value P to the communication module 230a in accordance with this demanding signal. The communication module 230a receives the body pressure value P from each of the adjacent communication modules 230b (S26). The communication module 230a also stores the body pressure value P at the corresponding one of the addresses M (−1, 1), M (0, 1), M (1, 1), M (−1, 0), M (1, 0), M (−1, −1), M (0, 1), and M (1, −1) of the memory 236, each of the addresses being associated with the local address of each of the adjacent communication modules 203b (S27).

The controlling part 232, next, calculates a pressure difference pr between each of the eight body pressure values P and the body pressure value P detected by its own pressure sensor 234 (S28). Specifically, the pressure difference pr is represented as the absolute value of the difference between each of the body pressure values P stored at the addresses M (i, j) (where, i=−1˜1, j=−1˜1) other than M (0, 0) and the body pressure value P stored at M (0, 0).

The controlling part 232 judges whether at least one of the eight pressure differences is higher than a third threshold (S29). In this step, when at least one of the eight pressure differences pr is judged equal to or higher than the third threshold (S29: YES), it means that such a high-pressure is locally applied to the pressure-detecting mat 200 that it is possible for the patient 1 to suffer from decubitus. As a result, the controlling part 232 generates the warning signal, which is outputted to the control unit 220 together with the ID information stored in the memory 236 (S30). On the other hand, when each of the eight pressure differences pr is judged lower than the third threshold (S29: NO), it does not mean that such a high pressure is applied to the pressure-detecting mat 200 that the patient 1 is likely to suffer from decubitus. Therefore, the controlling part 232 makes the process proceed to S31 without generating the warning signal, and, after waiting ready for a predetermined time T, goes back to S21 to continue the process shown in this flowchart.

It is noted that when a pressure is locally applied to a body region of the patient 1, even though the pressure is lower than the first threshold corresponding to a pressure that is likely to strain the patient 1, it is possible for the patient 1 to suffer from decubitus. For this reason, the third threshold is set lower than the first threshold employed in the aforementioned S6. The controlling part 232 warns about the possibility of the patient 1 suffering decubitus through the judgment processing employing the pressure difference pr between the pressure detected by the communication module 230a and that detected by each of the adjacent communication modules 230b.

Next, the constitution and operation of the control unit 220 that performs comprehensive control of the pressure-detecting mat 200 will be explained. The major functions of the control unit 220 are to carry out the comprehensive control of the pressure-detecting mat 200 and to make the monitor 300 display the warning signal received from the communication module 230.

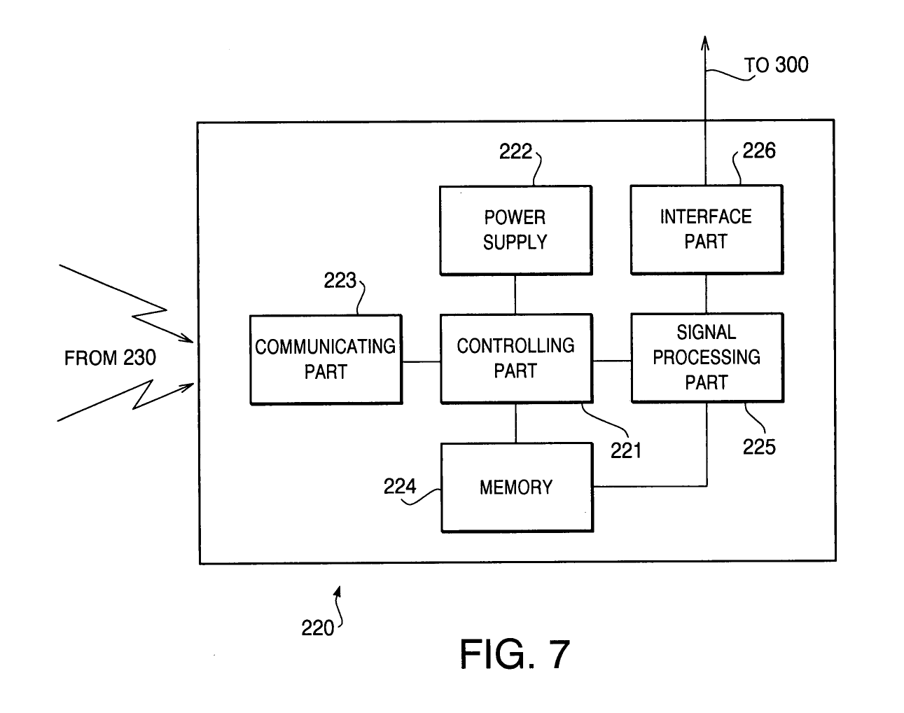

FIG. 7 is a block diagram showing the configuration of the control unit 220. The control unit 220 is provided with a controlling part 221 that carries out the comprehensive control of the pressure-detecting mat 200, a power supply 222 that functions as a power supply of the whole of the pressure-detecting mat 200, a communicating part 223 for communicating with each communication module 230 through the conductive layers 212 and 214, a memory that stores various kinds of data including various control programs and the obtained warning signal, a signal processing part 225 that processes the obtained warning signal to be displayed on the monitor 300, and an interface part 226 for connecting to external devices and outputting the warning signal to the external devices (in this case, connecting to the control unit 220 and the monitor 300). The warning signal obtained by each communication module 230 is processed by the control unit 220 to be displayed on the monitor 300.

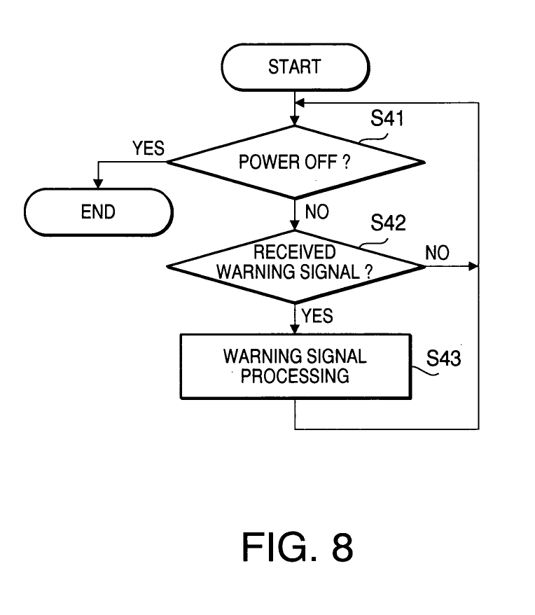

FIG. 8 is a flowchart showing a warning signal converting processing of the control unit 220 (more specifically, the controlling part 221) in the first and second embodiments, the warning signal converting processing making it for the monitor 300 to display the obtained warning signal. Hereinafter, the warning signal converting processing will be explained with reference to FIG. 8.

When the power switch (which is not shown in any of the accompanying drawings) of the control unit 220 is turned on, the power supply 222 supplies electrical power to the control unit 220 to drive the control unit 220. The controlling part 221 is allowed to communicate with each communication module 230 by using the 2D-DST. Then, the controlling part 221 checks whether the above power switch is off (S41). When the power switch is off (S41: YES), this process is terminated. On the other hand, when the power switch is on (S41: NO), this process proceeds to S42.

In S42, the controlling part 221 judges whether it has received the warning signal from the communication module 230. In this step, when the controlling part 221 judges that it has not received the warning signal (S42: NO), the controlling part 221, going back to S41, continues this process. On the other, when the controlling part 221 judges that it has received the warning signal (S42: YES), the controlling part 221 outputs the warning signal to the signal processing part 225, which processes the warning signal such that the warning signal is displayed on the monitor 300 (S43). Then, the controlling part 221 goes back to S41 to continue this process.

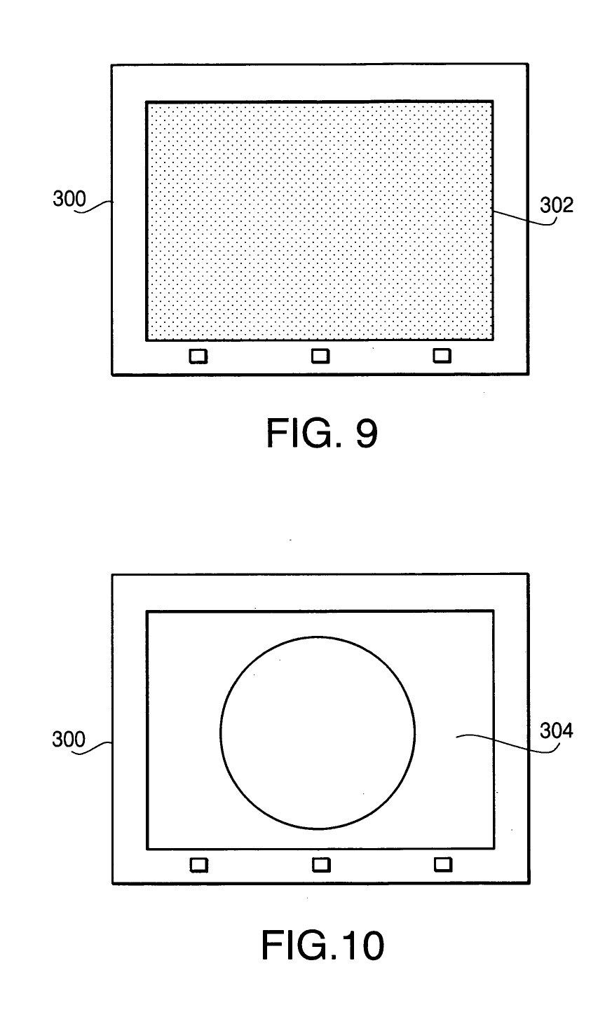

The warning signal processed by the signal processing part 225 is transmitted to the monitor 300 through the interface part 226. Thereby, a warning for preventing the patient 1 from suffering decubitus is displayed on the monitor 300. FIGS. 9-14 show various examples of the warning indications displayed on the monitor 300.

In an example of the warning indications shown in FIG. 9, according to a period when a pressure that is likely to result in the patient 1 suffering decubitus is being applied to the pressure-detecting mat 200 (in other words, a period when the communication module 230 is continuously receiving the warning signal), warning colors 302 are displayed on the monitor 300. The warning color includes “red”, “yellow”, and “blue”, which represent higher need for rolling over the patient 1 in order, in this case. When the above-mentioned period is longer than 10 minutes, the warning color 302 of red is displayed on the monitor 300. When the period is longer than 5 minutes and shorter than 10 minutes, the warning color 302 of yellow is displayed on the monitor 300. When the period is longer than 1 minute and shorter than 5 minutes, the warning color 302 of blue is displayed on the monitor 300.

In an example of the warning indications shown in FIG. 10, warning graphic forms 304 such as a demerit mark, a triangle, and a circle are displayed on the monitor 300. The demerit mark corresponds to the above warning color of red. The triangle corresponds to the warning color of yellow. The circle corresponds to the warning color of blue.

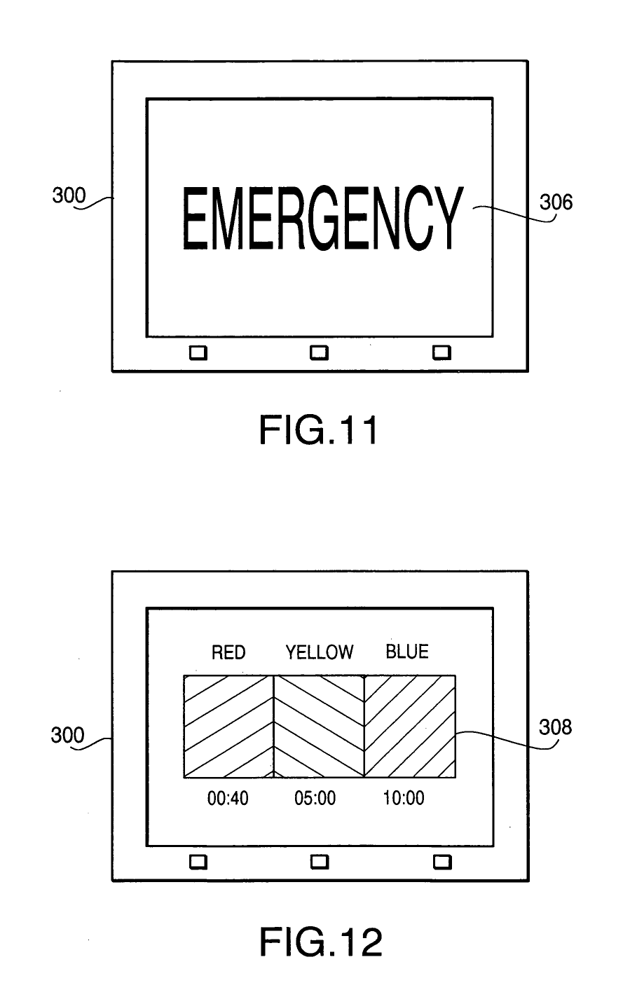

In an example of the warning indications shown in FIG. 11, warning signs 306 such as “EMERGENCY”, “CAUTION”, and “ATTENTION” are displayed on the monitor 300. The “EMERGENCY” corresponds to the warning color of red. The “CAUTION” corresponds to the warning color of yellow. The “ATTENTION” corresponds to the warning color of blue.

In an example of the warning indications shown in FIG. 12, on the monitor 300, there is displayed a warning graph 308 that shows warning colors, each of which represents a corresponding pressure level with an indication of time below which represents duration of the corresponding pressure level. In this example, the warning colors of “red”, “yellow”, and “blue” are employed in the warning graph to represent higher pressure being applied to the pressure-detecting mat 200 (in other words, to any body region of the patient 1), in order. In addition, the time indicated below each of the warning colors represents the duration of a pressure that satisfies an indication condition of each of the warning colors. In this example, a time indication of “00:40” shown below the warning color of “red” means an extremely high pressure that satisfies the indication condition of the warning color of “red” being applied to the pressure-detecting mat 200 during the duration of 40 seconds. Moreover, a time indication of “05:00” shown below the warning color of “yellow” means such a high pressure as to satisfy the indication condition of the warning color of “yellow”, but not to satisfy that of the warning color of “red” being applied to the pressure-detecting mat 200 during the duration of 5 minutes. Further, a time indication of “10:00” shown below the warning color of “blue” means such a high pressure as to satisfy the indication condition of the warning color of “blue”, but that does not satisfy that of the warning color of “yellow” being applied to the pressure-detecting mat 200 during the duration of 10 minutes.

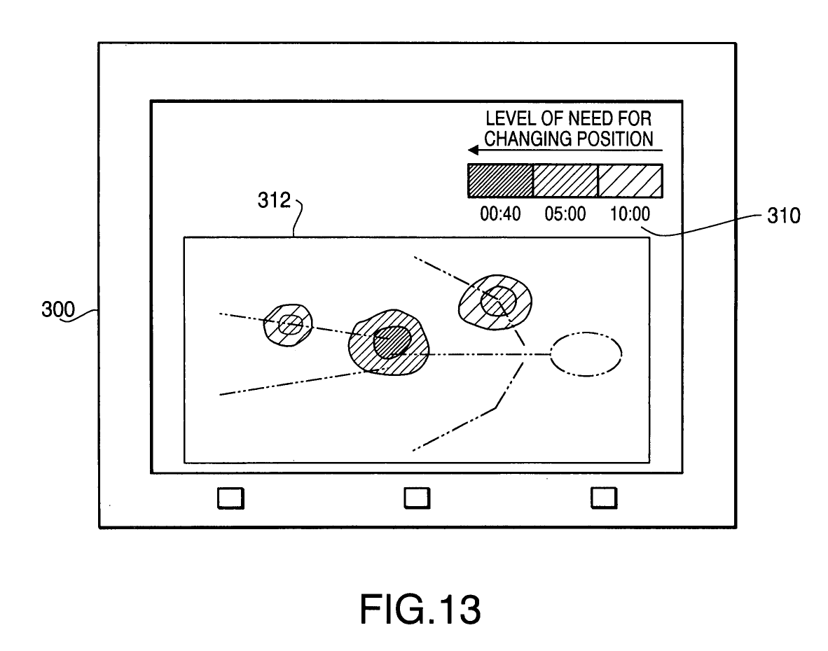

In an example of the warning indications shown in FIG. 13, on the monitor 300, there is displayed, at the upper right corner of the screen, a warning graph 310 with warning colors and indications of duration that are indicated under the same conditions as in the case of the warning graph 308. On the whole screen, there is also displayed, below the warning graph, a pressure distribution over the entire area of the pressure-detecting mat 200. It is noted that although a body figure is shown in the pressure distribution 312 for the sake of convenience, it is not actually indicated. However, in order to make an operator easily understand the positional relationship between the patient 1 and the pressure distribution 312, such a body figure as shown in FIG. 13 may be displayed on the monitor 300.

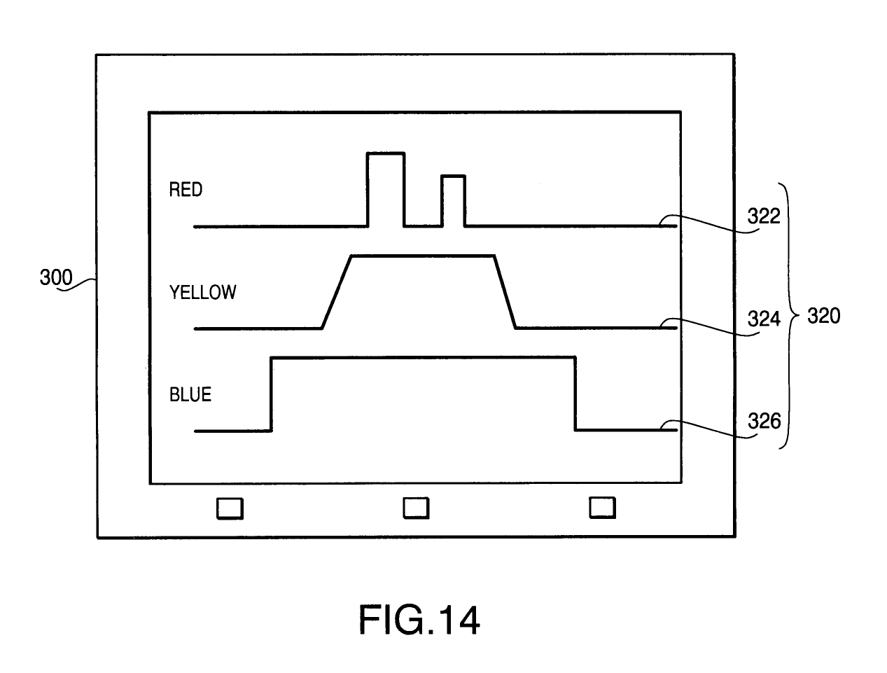

In an example of the warning indications shown in FIG. 14, there is displayed a warning graph 320 that includes three charts of the time-series data, each of which is indicated by one of the colors of “red”, “yellow”, and “blue”, according to the level of the pressure. That is to say, the colors of “red”, “yellow”, and “blue” employed in the warning graph represents higher pressure being applied to the pressure-detecting mat 200 in order, in the same way as the example shown in FIG. 12. The horizontal axis of each chart represents “time”. Pulse width of a rectangular wave in each chart represents the duration of such a high pressure as to satisfy the indication condition of each of the colors being applied to the pressure-detecting mat 200.

Hereinabove, the first and second embodiments according to the present invention have been described. However, the scope of the present invention is not limited by the embodiments. It is noted that variations of the embodiments and/or any different combinations of features of the present invention are possible.

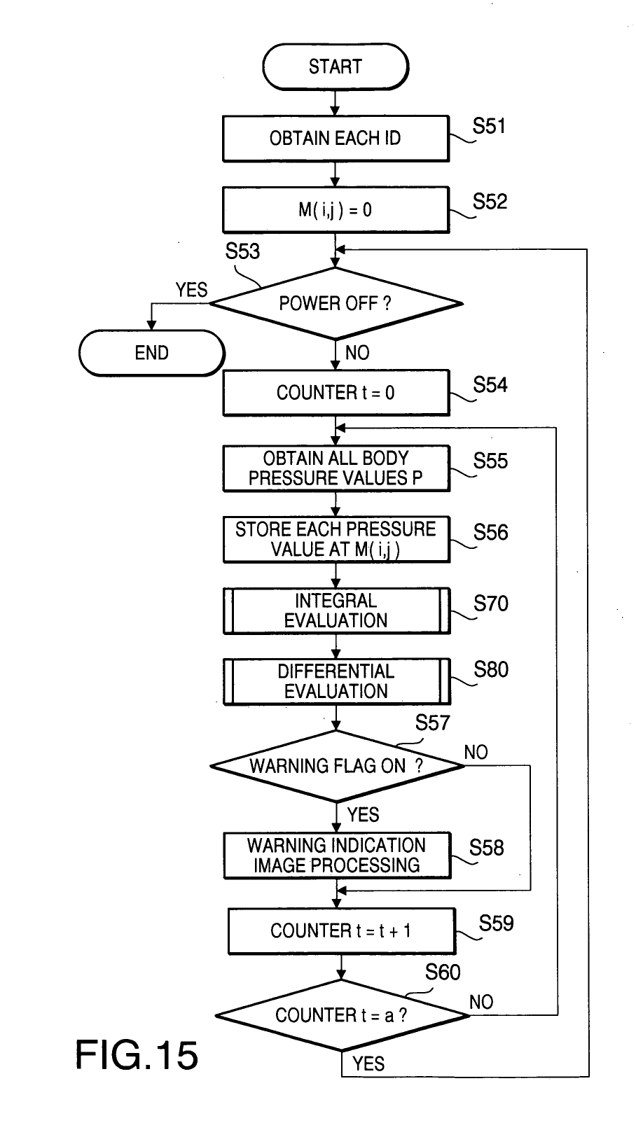

In the first and second embodiments, each of the communication modules 230 carries out the body pressure judging process, while, in a third embodiment, a control unit 220 may perform such a body pressure judging process. FIG. 15 is a flowchart showing a body pressure judging process performed by a control unit 220 in the third embodiment. Hereinafter, the body pressure judging process in the third embodiment will be explained with reference to FIG. 15. In the below-mentioned description, the same components as described above are designated by the same reference numbers, and detailed explanations will be omitted regarding them.

When a power switch of the control unit 220, which is not shown in any accompanying drawings, is turned on, the power supply 222 supplies electrical power to the control unit 220 to drive the control unit 220. The controlling part 221 is allowed to communicate with each of the communication modules 230 by using the aforementioned 2D-DST. In the third embodiment, each of the communication modules 230 acquires its own ID information by means of an algorithm stored in each of the controlling parts 232 to transmit the ID information to the control unit 220.

The controlling part 221 of the control unit 220 receives the ID information from each of the communication modules 230 (S51), and, based on the ID information, identifies each of the communication modules 230. In addition, the controlling part 221 has the ID information associated with the local addresses, and stores the body pressure value P detected by each of the communication modules 230 at a corresponding one of the addresses of the memory 224, the corresponding address having the same code as the local address of each of the communication modules 230.

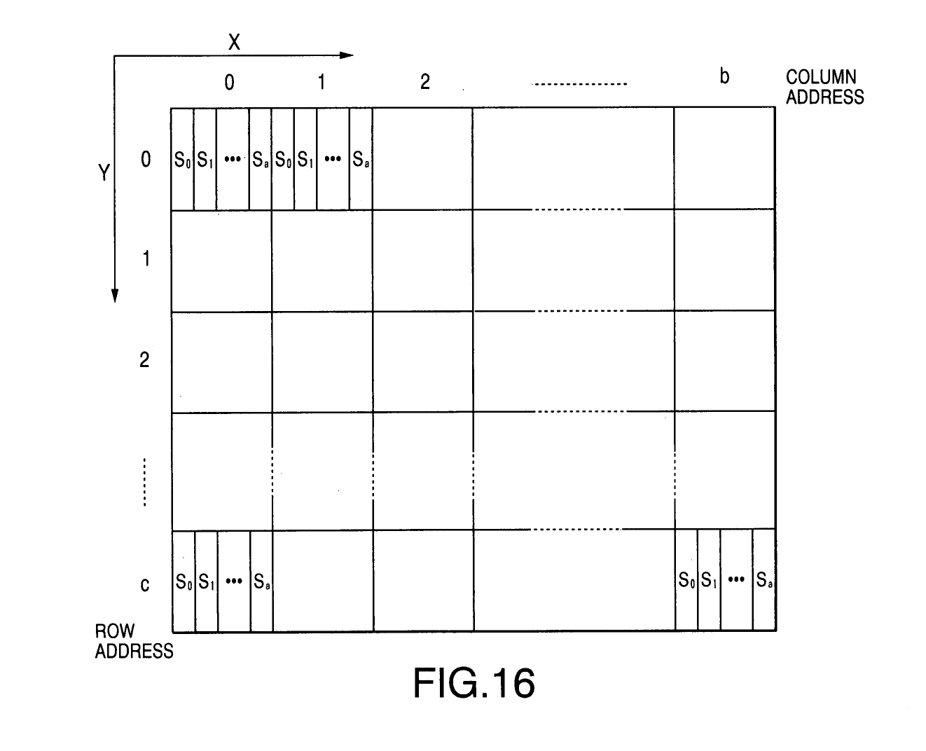

FIG. 16 conceptually shows an address structure of the memory 224 to make it easy to explain the process in this flowchart. In FIG. 16, the address structure of the memory 224 designated for storing the body pressure values P is configured as a matrix that has (C+1) row addresses of 0 to c and (b+1) column addresses of 0 to b. In addition, each of the addresses is divided into a plurality of segments St (t=0˜a) so as to store (a+1) body pressure values P. It is noted that X direction is a column address direction, and that Y direction is a row address direction in FIG. 16.

After finishing with setting regarding the ID information of each of the communication module 230, the controlling part 221 sets values stored in all the segments St of all the addresses M (i, j) (where i=0˜b, j=0˜c) equal to zero (S52). Then, the controlling part 221 judges whether the above power switch is off (S53). When the power switch is off (S53: YES), this process is terminated. When the power switch is on (S53: NO), this process proceeds to S54.

The controlling part 221 sets a counter t associated with each of the segments St equal to zero (S54), and obtains the body pressure values P of the patient 1 detected by all the communication modules 230 in the pressure-detecting mat 200 (S55). Then, each of the body pressure value P is stored in one of the segments St of each of the addresses M (i, j) that is associated with each of the communication modules 230 (S56). In this step, the segment St that stores the body pressure value P is a segment that is associated with the current value of the counter t. For example, when the counter t=0, each of the body pressure values P is stored in the segment S₀ of a corresponding one of the addresses M (i, j).

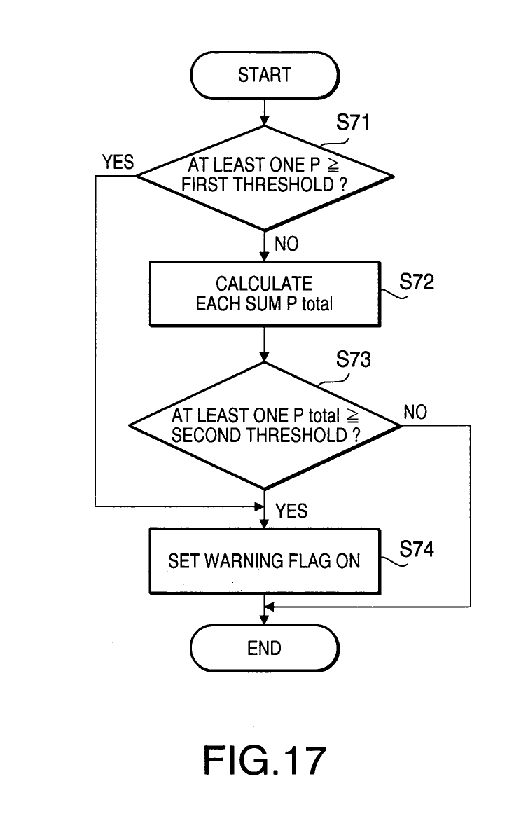

When the body pressure value P is stored in each of the segments St, the controlling part 221 carries out the body pressure judging process according to an integral evaluation. FIG. 17 is a flowchart showing the body pressure judging process according to the integral evaluation in S70. Hereinafter, processing in S70 will be explained referred to FIG. 17.

The controlling part 221 first judges whether each of the body pressure values P stored in S56 is higher than a first threshold (S71). In this step, when at least one of the body pressure values P is judged equal to or higher than the first threshold (S71: YES), it means that such an extremely high pressure is applied to at least one part of the pressure-detecting mat 200 that it is possible for the patient 1 to suffer from decubitus. Accordingly, the controlling part 221 sets a warning flag for carrying out warning processing on (S74) to make the process proceed to S80 shown in FIG. 15. On the other hand, when all the body pressure values P are judged lower than the first threshold (S71: NO), it does not mean that such a high pressure is applied to the pressure-detecting mat 200 that the patient 1 is likely to suffer from decubitus. Consequently, the controlling part 221 makes the process go forward to S72 without setting the warning flag on.

The controlling part 221 calculates a summation of all the body pressure values P at each of the addresses M (i, j), i.e., a summation Ptotal of all the body pressure values P stored in the segments St (t=0˜a) (S72), and judges whether each of the summations Ptotal is higher than a second threshold (S73). In this step, when at least one of the summations Ptotal is judged equal to or higher than the second threshold (S73: YES), it means that such a high pressure is continually applied to at least one part of the pressure-detecting mat 200 that it is possible for the patient 1 to suffer from decubitus. Therefore, the controlling part 221 sets the warning flag on (S74), and make the process proceed to S80 of the flowchart shown in FIG. 15. On the other hand, when all the summation Ptotal are judged lower than the second threshold (S73: NO), it does not mean that such a high pressure is applied to the pressure-detecting mat 200 that the patient 1 is likely to suffer from decubitus. Thus, the controlling part 221 makes the process proceed to S80 of the flowchart shown in FIG. 15 without setting the warning flag on.

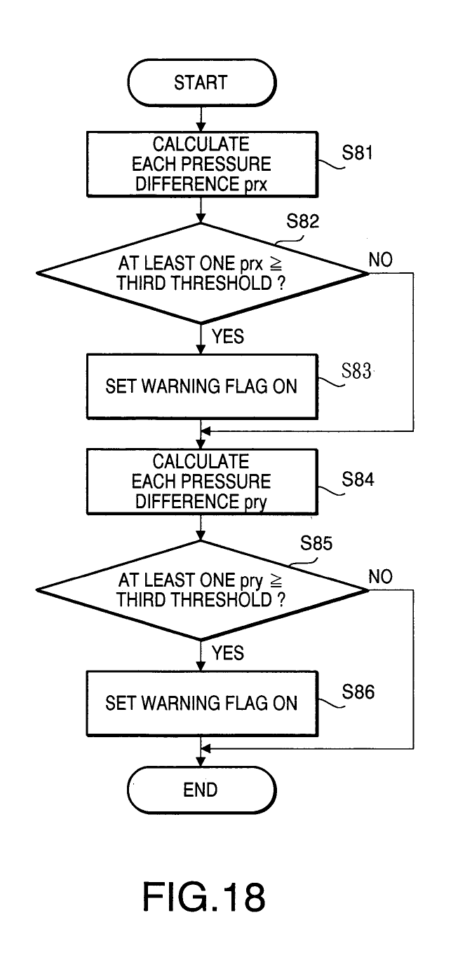

FIG. 18 is a flowchart showing a body pressure judging process according to a differential evaluation in S80. Hereinafter, the body pressure judging process according to the differential evaluation in S80 will be explained with reference to FIG. 18.

The controlling part 221 first calculates a pressure difference prx that is a difference between body pressure values P detected by two communication modules 230 which are associated with an adjacent couple of the addresses in the X direction in FIG. 16 (S81). More specifically, the pressure difference prx is defined as an absolute value of the difference between the body pressure value P stored in the segment St, which is associated with the current value of the counter t, at the address M (i, j) and the body pressure value P stored in the segment St, which is associated with the current value of the counter t, at the address M (i+1, j) adjacent to the address M (i, j) in the X direction. It is noted that the pressure differences prx are calculated with respect to the body pressure values P stored at all the addresses.

Then, the controlling part 221 judges whether each of the pressure differences prx is higher than a third threshold (S82). In this step, when at least one of the pressure differences prx is judged equal to or higher than the third threshold (S82: YES), it means that such a high pressure is locally applied to the pressure-detecting mat 200 that it is possible for the patient 1 to suffer from decubitus. Accordingly, the controlling part 221 sets the warning flag on (S83) to make the process proceed to S84. On the other, when all the pressure differences prx are judged lower than the third threshold (S82: NO), it does not mean that such a high pressure is applied to the pressure-detecting mat 200 that the patient 1 is likely to suffer from decubitus. Therefore, the controlling part 221 makes the process go forward to S84 without setting the warning flag on.

The controlling part 221, next, calculates a pressure difference pry that is a difference between the body pressure values P detected by two communication modules 230 which are associated with an adjacent couple of the addresses in the Y direction in FIG. 16 (S84). More specifically, the pressure difference pry is defined as an absolute value of the difference between the body pressure value P stored in the segment St, which is associated with the current value of the counter t, at the address M (i, j) and the body pressure value P stored in the segment St, which is associated with the current value of the counter t, at the address M (i, j+1) adjacent to the address M (i, j) in the X direction. It is noted that the pressure differences pry are calculated with respect to the body pressure values P stored at all the addresses.

Then, the controlling part 221 judges whether each of the pressure differences pry is higher than the third threshold (S85). In this step, when at least one pressure difference pry is judged equal to or higher than the third threshold (S85: YES), it means that such a high pressure is locally applied to the pressure-detecting mat 200 that it is possible for the patient 1 to suffer from decubitus. Accordingly, the controlling part 221 sets the warning flag on (S86) to make the process proceed to S57. On the other hand, when all the pressure difference pry are judged lower than the third threshold (S85: NO), it does not mean that such a high pressure is applied to the pressure-detecting mat 200 that the patient 1 is likely to suffer from decubitus. Thus, the controlling part 221 makes the process go forward to S57 of the flowchart shown in FIG. 15 without setting the warning flag on.

In the processing in S57 of the flowchart shown in FIG. 15, the controlling part 221 checks whether the warning flag is set on. In this step, when the warning flag is judged on (S57: YES), the controlling part 221 outputs a signal for instructing the monitor 300 to display the warning indication to the signal processing part 225, which then process the signal such that the monitor 300 can display the warning indication (S58). The signal that is processed by the signal processing part 225 is outputted to the monitor 300 through the interface part 226. Thereby, the warning indication for preventing the patient 1 from suffering decubitus is displayed on the monitor 300. When the warning flag is judged off (S57: YES), the controlling part 221 increments the counter t by one (S59) to make the process proceed to S60.

In S60, the controlling part 221 checks whether the current setting value of the counter t is equal to a (S60). In this step, when the current value of the counter t is a (S60: YES), it means that all the segments St for storing the body pressure values P are used. Therefore, the controlling part 232, going back to S53, carries out this process again. When the current value of the counter t is not a (S60: NO), it means that all the segments St for storing the body pressure values P are not used. Thus, the controlling part 232, going back to S55, acquires the body pressure value P again, and repeats the aforementioned process.

It is noted that the process of S56 to S60 is repeatedly carried out every predetermined timing (for instance, every aforementioned first timing). As a result, the controlling part 232 obtains each of the body pressure values P every predetermined timing. In addition, the summation Ptotal is obtained every timing (for instance, every aforementioned second timing), the time interval between one of the timings and the next one being longer than that between one of the above predetermined timings and the next one.

If the control unit 220 comprehensively carries out the body pressure judging process, which is carried out by each of the communication modules 230 in the first and second embodiments, in the same way as the third embodiment, it will be possible to reduce the cost of each of the communication modules 230, and thereby, to reduce the pressure-detecting mat 200.

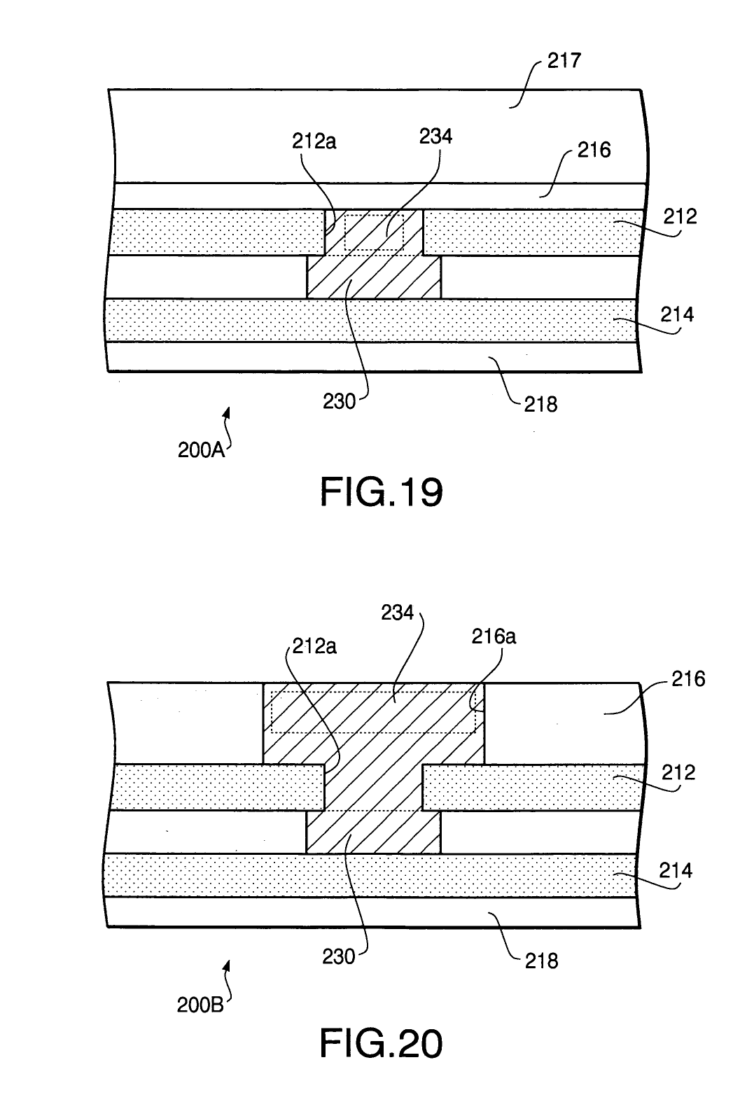

The pressure-detecting mat 200 has the cross-sectional structure as shown in FIG. 2 in the aforementioned embodiments. However, in a fourth embodiment, a pressure-detecting mat may have such a cross-sectional structure as to provide a more comfortable feeling to the patient 1 who sleeps thereon. FIG. 19 shows the cross-sectional structure of a pressure-detecting mat 200A in the fourth embodiment. Referred to FIG. 19, the pressure-detecting mat 200A is further provided with a thick and flexible layer 217 on the insulating layer 216 of the pressure-detecting mat 200 of the first embodiment. Thereby, the patient 1 can feel more comfortable while sleeping thereon. Optionally, the above flexible layer 217 may be detachable. Since the flexible layer 217 is the closest layer to the patient 1, it is more likely to become filthy. If the flexible layer 217 is detachable, it will be possible to keep it clean by cleaning it.

Moreover, in the first embodiment, since there is provided the insulating layer 216 between the pressure sensor 234 and the patient 1, a pressure detected by the pressure sensor 234 is reduced because of the elasticity of the insulating layer 216. In other words, the sensitivity of the pressure sensor 234 is lowered through the insulating layer 216. On the contrary, in a pressure-detecting mat 200B in a fifth embodiment shown in FIG. 20, the insulating layer 216 is formed with openings 216a in conformity with the locations of the respective openings 212a, and the pressure sensor 234 is disposed at the upper surface of the pressure-detecting mat 200 through each of the openings 216a. For this reason, the pressure sensor 234 has direct contact with the patient 1, and the pressure sensor 234 can detect the body pressure of the patient 1 without reduction of the sensitivity (in other words, with high S/N ratio).

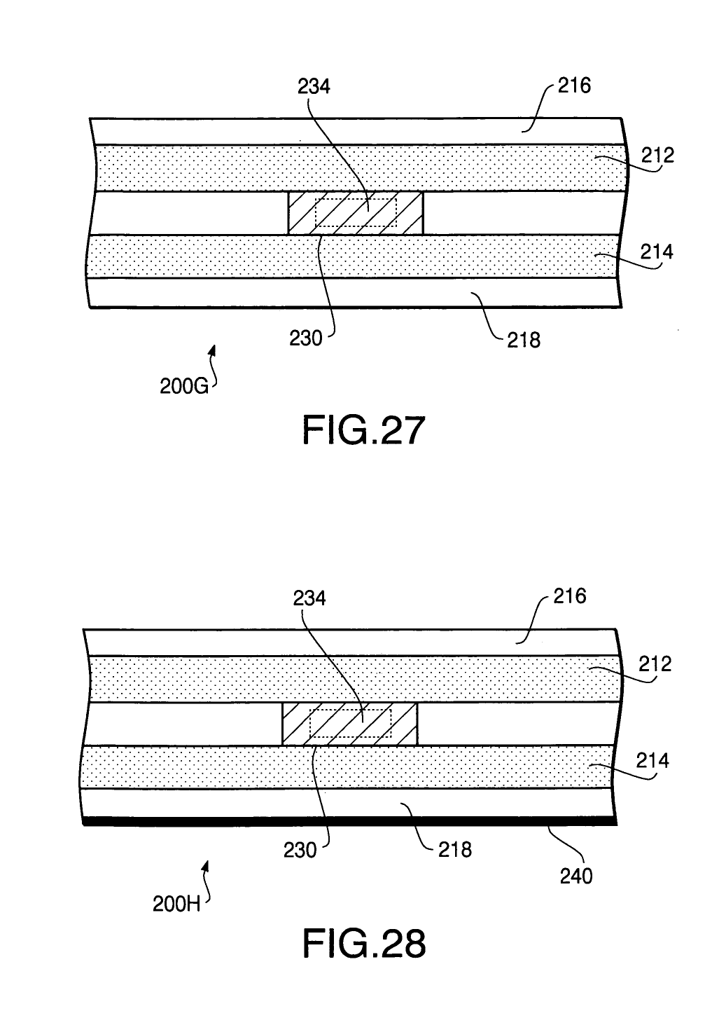

In the first embodiment, the conductive layer is formed with the openings 212a, and each of the pressure sensors 234 is incorporated in the opening 212a. On the contrary, in a pressure-detecting mat 200G in a sixth embodiment, the conductive layer 212 is not formed with the openings 212a, and there are provided the pressure sensors 234 between the conductive layers 212 and 214 (See FIG. 27). In this case, since it is unnecessary to form the openings 212a in the conductive layer 212, the cost of manufacturing can be reduced.

Furthermore, in a seventh embodiment, when both layers that sandwich the pressure sensors 234 have substantially the same stiffness, there may be provided a seat 240 with higher stiffness than any other layers, below the insulating layer 218 (that is, below the surface of the farthest layer of a pressure-detecting mat 200H from the patient 1 sleeping thereon), as shown in FIG. 28. Thereby, the pressure difference between both of the upper and lower sides of the pressure sensors 234 is increased such that the body pressure value is detected with high sensitivity. Optionally, the above seat 240 with high stiffness may be detachable.

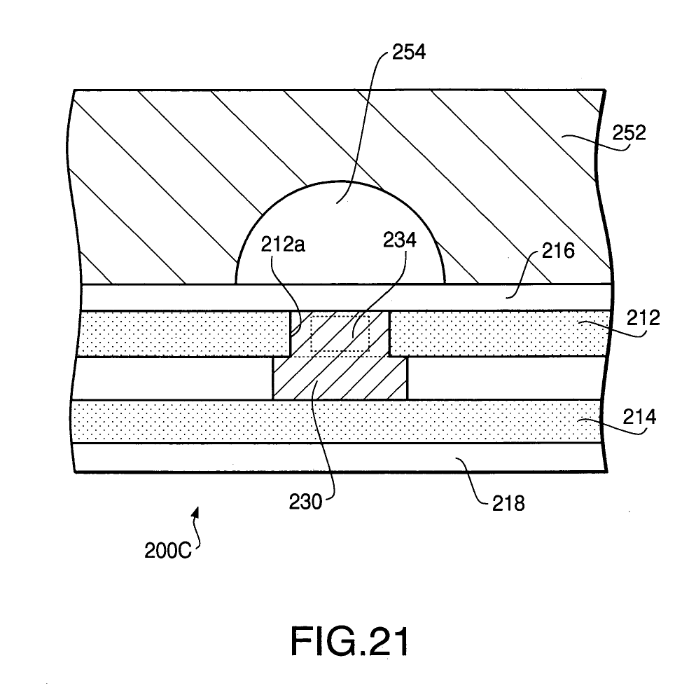

Moreover, in further embodiments, a layer including a plurality of chambers in which fluid is sealed may be provided on the pressure-detecting mat 200. FIGS. 21-24 show the cross-sectional structures of various types of pressure-detecting mats, each of which is provided with a layer including a plurality of chambers thereon.

In a pressure-detecting mat 200C shown in FIG. 21 (an eighth embodiment), there is provided a flexible layer 252 on the insulating layer 216. In this flexible layer 252, there is arranged the plurality of chambers 254 in conformity with the locations of the respective pressure sensors 234, like a matrix. Inside the chamber 254, there is sealed a material with flowability such as air, liquid, and gel, or an elastic material. When a pressure is applied to the chamber 254 from the side of the patient 1, the pressure is dispersed in every direction outside of the chamber 254 by the chamber 254 being deformed. Thereby, the dispersed pressure is applied to the entire area of the flexible layer 252 covering the chamber 254, and the reaction force of the patient's own weight from the flexible layer 252 is dispersed. For this reason, concentration of the pressure that is locally applied to the patient 1 is reduced. The pressure-detecting mat 200C provides a more comfortable feeling to the patient 1 sleeping thereon.

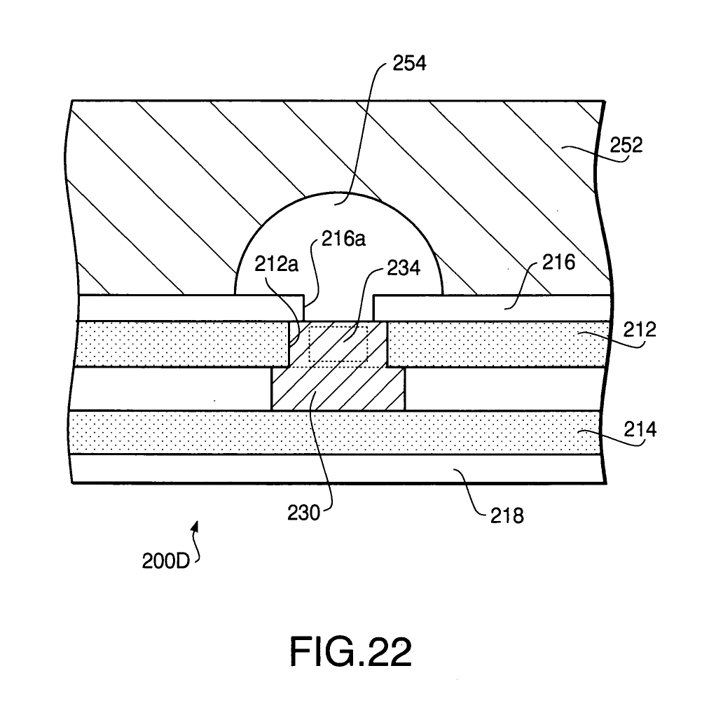

In a pressure-detecting mat 200D shown in FIG. 22 (a ninth embodiment), the insulating layer 216 of the pressure-detecting mat 200C is formed with a plurality of openings 216a in conformity with the locations of the respective pressure sensors 234. In this case of the pressure-detecting mat 200D, since the pressure sensor 234 has direct contact with the chamber 254, the sensitivity of the pressure sensor 234 (or the S/N ratio of the pressure sensor 234) is higher than that of the pressure-detecting mat 200C.

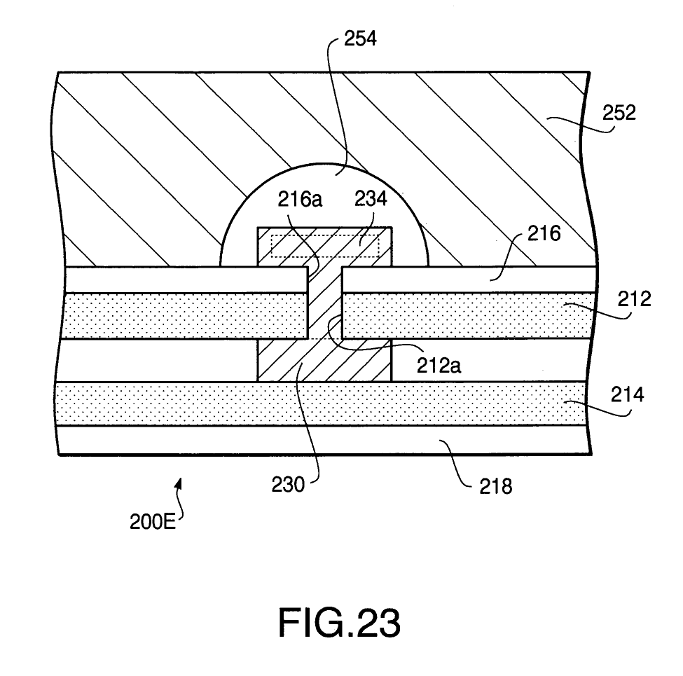

A pressure-detecting mat 200E shown in FIG. 23 (a tenth embodiment) is provided with communication modules 230, each of which are obtained by deforming the communication module 230 of the pressure-detecting mat 200D. Each of the pressure sensors 234 is located on the insulating layer 216. Thereby, the pressure sensor 234 can be designed more flexibly, and, for instance, can be increased in size. If the pressure sensor 234 is increased in size, the sensitivity of the pressure sensor 234 will be higher than that of the pressure-detecting mat 200D.

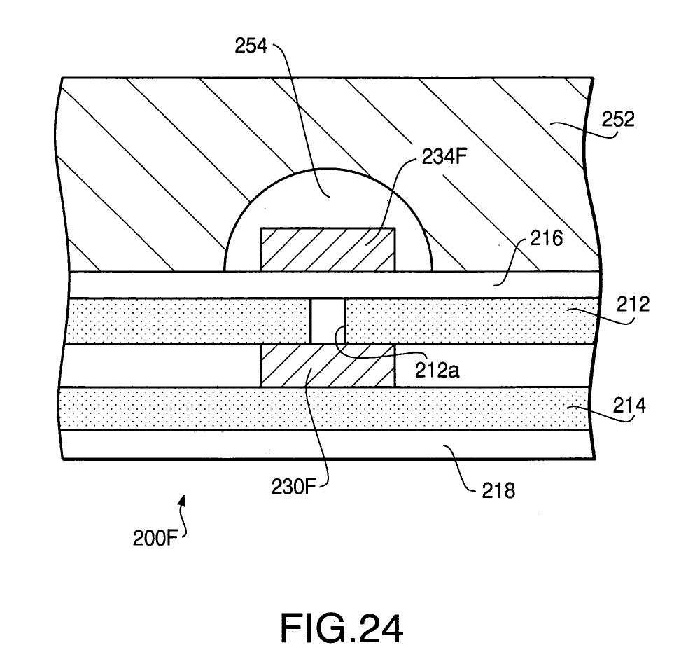

A pressure-detecting mat 200F shown in FIG. 24 (an eleventh embodiment) is not formed with any openings in the insulating layer 216. In the case of the pressure-detecting mat 200F, the communication module 230 of the aforementioned embodiments is divided into a communication module 230F for transmitting a signal by means of the 2D-DST and a pressure sensor module 234F for detecting a pressure. In the eleventh embodiment, the communication module 230F is arranged between the conductive layers 212 and 214, and the pressure sensor module 234F is located inside the chamber 254.

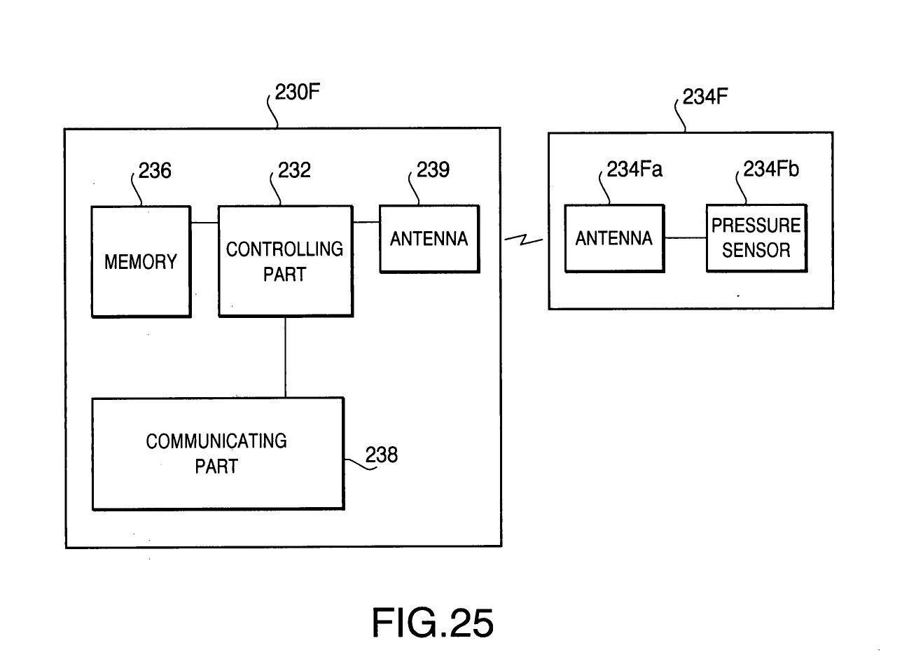

FIG. 25 is a block diagram showing the configurations of the communication module 230F and the pressure sensor module 234F. The communication module 230F is provided with an antenna 239 that sends and receives faint radio wave for communicating with adjacent external devices as well as the controlling part 232, memory 236, and communicating part 238. In addition, the pressure sensor module 234 is provided with an antenna 234Fa that sends and receives faint radio wave in the same way as the antenna 239 and a pressure sensing part 234Fb for detecting the body pressure of the patient 1. In this case, when the pressure sensing part 234Fb detects a pressure, the antenna 234Fa sends out a detecting signal, which is then received by the antenna 239 to be processed by the controlling part 232. That is, in this case, the pressure applied to the pressure-detecting mat 200F is detected and processed through wireless communication between the communication module 230F and the pressure sensor module 234F. In this way, if the communication module 230F is separated from the pressure sensor module 234F, it will be easier to incorporate the pressure sensor to the pressure-detecting mat 200. Moreover, since the insulating layer 216 is not formed with any opening, it is easier to seal the chamber 254. In addition, the communication module 230F can supply electrical power to the pressure sensor module 234F through the wireless communication.

In the aforementioned embodiments, the control unit 220 and the monitor 300 are connected with one another through a cable as shown in FIG. 1. However, in another embodiment, they may be connected with one another through wireless communication. In a further embodiment, the control unit 220 may be provided with a slot for a memory card. In this case, the warning signal and/or the body pressure value P that are associated with the ID information of each of the communication modules 230 can be stored in the memory card.

In the aforementioned embodiments, the warning about the possibility of the patient 1 suffering decubitus is given by using a displaying means, i.e., the monitor 300. In another embodiment, such a warning may be given by a warning sound. In this case, for example, the warning signal may be converted to an audio output signal through the signal processing part 225, and an external device to which the audio output signal is directed may be replaced from the “monitor 300” to a sound reproducing means such as a “speaker”. In a further embodiment, such a displaying means may be a lamp such as a multicolor lamp and a multicolor LED).

It is noted that the shape of the pressure-detecting mat 200, which is formed of a rectangular parallelepiped in the aforementioned embodiments, is not limited by a rectangular parallelepiped form. The pressure-detecting mat 200 may have one of other shapes such as a tubular type.

The present disclosure relates to the subject matter contained in Japanese Patent Application No. P2004-281351, filed on Sep. 28, 2004, which is expressly incorporated herein by reference in its entirely.

What is claimed is:

1. A pressure-detecting mat capable of detecting a pressure using a two dimension diffusive signal-transmission technology, comprising:
a plurality of communication modules that are configured to communicate with each other using the two dimension diffusive signal-transmission technology;
a module layer that includes the plurality of communication modules scattered therein;
a plurality of conductive layers that electrically interconnect the plurality of communication modules;
at least two insulating layers that sandwich the module layer and the plurality of conductive layers; and
a plurality of pressure sensors that are arranged in one of all the layers except the farthest layer in a pressure applying direction, each of the pressure sensors being capable of detecting a pressure and communicating with each of the communication modules to send an output signal according to the detected pressure to each of the communication modules,
wherein the total stiffness of the layers that are farther in the pressure applying direction than the layer in which the pressure sensors are arranged is higher than the total stiffness of the layers that are closer in the pressure applying direction than the layer in which the pressure sensors are arranged.

2. The pressure-detecting mat according to claim 1,
wherein, among at least two insulating layers, one of the layers that are farther in the pressure applying direction than the layer in which the pressure sensors are arranged has higher stiffness than any other layers.

3. The pressure-detecting mat according to claim 1,
wherein each of the communication modules is configured to judge whether the output signal from a corresponding one of the pressure sensors satisfies at least one predetermined condition,
wherein each of the communication modules is configured to transmit a warning signal for warning about that the output signal is abnormal to an external system, when one of the communication modules judges that the output signal satisfies the at least one predetermined condition.

4. The pressure-detecting mat according to claim 3,
wherein each of the communication modules is configured to transmit its own ID information to the external system, when one of the communication modules judges that the output signal satisfies at least one predetermined condition.

5. The pressure-detecting mat according to claim 3,
wherein the at least one predetermined condition includes a first condition that the output signal is equal to or higher than a first threshold.

6. The pressure-detecting mat according to claim 3,
wherein each of the pressure sensors is configured to detect a pressure and to send the output signal according to the detected pressure to each of the communication modules every first timing,
wherein each of the communication modules is configured to calculate every second timing a summation of all of the output signals received every first timing thereby during a period between the previous second timing and the second timing, the period between each adjacent couple of the second timings being longer than the period between each adjacent couple of the first timings, and
wherein the at least one predetermined condition includes a second condition that the calculated summation is equal to or higher than a second threshold, the second threshold being higher than the first threshold.

7. The pressure-detecting mat according to claim 3,
wherein each of the communication modules is configured to calculate a difference between the output signals from each adjacent couple of the pressure sensors, and
wherein the at least one predetermined conditions includes a third condition that the calculated difference is equal to and higher than a third threshold, the third threshold being lower than the first threshold.

8. The pressure-detecting mat according to claim 3,
wherein each of the pressure sensors is configured to detect a pressure and send the output signal according to the detected pressure to each of the communication modules every first timing,
wherein each of the communication modules is configured to calculate every second timing a summation of all of the output signals received every first timing thereby during a period between the previous second timing and the second timing, the period between each adjacent couple of the second timings being longer than the period between each adjacent couple of the first timings,
wherein each of the communication modules is configured to calculate a difference between the output signals from each adjacent couple of the pressure sensors, and
wherein the at least one predetermined condition includes:
a first condition that the output signal is equal to or higher than a first threshold;
a second condition that the calculated summation is equal to or higher than a second threshold, the second threshold being higher than the first threshold; and
a third condition that the calculated difference is equal to and higher than a third threshold, the third threshold being lower than the first threshold.

9. An antidecubitus system comprising the pressure-detecting mat according to claim 3 and the external system that is configured to receive the warning signal,
wherein the external system includes:
a controlling system that is configured to communicate with each of the plurality of communication modules; and
a warning system that is configured to warn about an abnormal pressure being applied to the pressure-detecting mat, the warning system being connected with the controlling system,
wherein the controlling system instructs the warning system to warn about an abnormal pressure being applied to the pressure-detecting mat in accordance with the received warning signal.

10. An antidecubitus system comprising the pressure-detecting mat according to claim 4 and the external system that is configured to receive the warning signal,
wherein the external system includes:
a controlling system that is configured to communicate with each of the plurality of communication modules; and
a warning system that is configured to warn about an abnormal pressure being applied to the pressure-detecting mat, the warning system being connected with the controlling system,
wherein the controlling system instructs the warning system to warn about an abnormal pressure being applied to the pressure-detecting mat in accordance with the received warning signal.

11. An antidecubitus system comprising the pressure-detecting mat according to claim 5 and the external system that is configured to receive the warning signal,
wherein the external system includes:
a controlling system that is configured to communicate with each of the plurality of communication modules; and
a warning system that is configured to warn about an abnormal pressure being applied to the pressure-detecting mat, the warning system being connected with the controlling system,
wherein the controlling system instructs the warning system to warn about an abnormal pressure being applied to the pressure-detecting mat in accordance with the received warning signal.

12. An antidecubitus system comprising the pressure-detecting mat according to claim 6 and the external system that is configured to receive the warning signal,
wherein the external system includes:
a controlling system that is configured to communicate with each of the plurality of communication modules; and
a warning system that is configured to warn about an abnormal pressure being applied to the pressure-detecting mat, the warning system being connected with the controlling system,
wherein the controlling system instructs the warning system to warn about an abnormal pressure being applied to the pressure-detecting mat in accordance with the received warning signal.

13. An antidecubitus system comprising the pressure-detecting mat according to claim 7 and the external system that is configured to receive the warning signal,
wherein the external system includes:
a controlling system that is configured to communicate with each of the plurality of communication modules; and
a warning system that is configured to warn about an abnormal pressure being applied to the pressure-detecting mat, the warning system being connected with the controlling system,
wherein the controlling system instructs the warning system to warn about an abnormal pressure being applied to the pressure-detecting mat in accordance with the received warning signal.

14. An antidecubitus system comprising the pressure-detecting mat according to claim 8 and the external system that is configured to receive the warning signal,
wherein the external system includes:
a controlling system that is configured to communicate with each of the plurality of communication modules; and
a warning system that is configured to warn about an abnormal pressure being applied to the pressure-detecting mat, the warning system being connected with the controlling system,
wherein the controlling system instructs the warning system to warn about an abnormal pressure being applied to the pressure-detecting mat in accordance with the received warning signal.

15. An antidecubitus system comprising the pressure-detecting mat according to claim 1 and an external system,
wherein each of the communication modules is configured to transmit the output signal to the external system,
wherein the external system includes:
a controlling system that is configured to communicate with each of the plurality of communication modules to receive the output signal; and
a warning system that is configured to warn about an abnormal pressure being applied to the pressure-detecting mat, the warning system being connected with the controlling system,
wherein the controlling system judges whether the output signal satisfies at least one predetermined condition,
wherein the controlling system instructs the warning system to warn about an abnormal pressure being applied to the pressure-detecting mat, when the controlling system judges that the output signal satisfies the at least one predetermined condition.

16. The antidecubitus system according to claim 15,
wherein each of the communication modules is configured to transmit its own ID information to the controlling system, and
wherein the controlling system is configured to receive the ID information from each of the communication modules.

17. The antidecubitus system according to claim 15,
wherein the at least one predetermined condition includes a first condition that the output signal is equal to or higher than a first threshold.

18. The antidecubitus system according to claim 15,
wherein each of the pressure sensors is configured to detect a pressure and to send the output signal according to the detected pressure to each of the communication modules every first timing,
wherein the controlling system receives the output signal from each of the communication modules every first timing to calculate every second timing a summation of all of the output signals during a period between the previous second timing and the second timing, the period between each adjacent couple of the second timings being longer than the period between each adjacent couple of the first timings, and
wherein the at least one predetermined condition includes a second condition that the calculated summation is equal to or higher than a second threshold, the second threshold being higher than the first threshold.

19. The antidecubitus system according to claim 15,
wherein the controlling system is configured to calculate a difference between the output signals from each adjacent couple of the pressure sensors, and
wherein the at least one predetermined conditions includes a third condition that the calculated difference is equal to and higher than a third threshold, the third threshold being lower than the first threshold.

20. The antidecubitus system according to claim 16,
wherein each of the pressure sensors is configured to detect a pressure and send the output signal according to the detected pressure to each of the communication modules every first timing,
wherein the controlling system receives the output signal from each of the communication modules every first timing to calculate every second timing a summation of all of the output signals received every first timing thereby during a period between the previous second timing and the second timing, the period between each adjacent couple of the second timings being longer than the period between each adjacent couple of the first timings,
wherein the controlling system is configured to calculate a difference between the output signals from each adjacent couple of the pressure sensors, and
wherein the at least one predetermined condition includes:
a first condition that the output signal is equal to or higher than a first threshold;
a second condition that the calculated summation is equal to or higher than a second threshold, the second threshold being higher than the first threshold; and
a third condition that the calculated difference is equal to and higher than a third threshold, the third threshold being lower than the first threshold.
